(19) United States
(12) Patent Application Publication
(10) Pub. No.: US 2015/0175417 A1
(43) Pub. Date: Jun. 25, 2015

(54) METHOD FOR MODIFYING CARBON DIOXIDE USING CARBON BLACK CATALYST

(71) Applicants: SK Innovation Co., Ltd., Seoul (KR); SK Global Chemical Co., Ltd., Seoul (KR)

(72) Inventors: Ji Min Kim, Daejeon (KR); Gui Young Han, Gyeonggi-do (KR)

(21) Appl. No.: 14/409,754

(22) PCT Filed: Jun. 10, 2013
(86) PCT No.: PCT/KR2013/005070

§ 371 Date: Dec. 19, 2014

(30) Foreign Application Priority Data
Jun. 25, 2012 (KR) 10-2012-0067906

(51) Int. Cl. C01B 3/40; C01B 3/48; B01J 21/18

(52) U.S. Cl. CPC C01B 3/40; B01J 21/18; C01B 3/48; C01B 2203/0238; C01B 2203/0283; C01B 2203/1011; C01B 2203/1041; C01B 2203/1235; C01B 2203/042

(57) ABSTRACT

The present invention relates to a method including a step of manufacturing a synthetic gas of carbon monoxide and hydrogen by reacting a hydrocarbon and carbon dioxide with a carbon black catalyst.

### TECHNICAL FIELD

The present invention relates to a method of reforming carbon dioxide. More particularly, the present invention relates to a method of producing synthesis gas by carbon dioxide reforming using a carbon black catalyst.

### BACKGROUND ART

Carbon dioxide is produced as a byproduct in a variety of processes, including combustion of fossil fuel, generation of chemicals, preparation of synthetic fuel, etc. Although carbon dioxide may be diluted in air, carbon dioxide is known as a main cause of global warming and is thus classified as a restricted material. Therefore, techniques for preventing or decreasing generation of carbon dioxide from a carbon dioxide supply source or for effectively capturing and removing the produced carbon dioxide have been developed.

As for chemical treatment of carbon dioxide, reacting a hydrocarbon such as methane and carbon dioxide in the presence of a catalyst as shown in Scheme (1) below to produce synthesis gas as a mixture of carbon monoxide and hydrogen is receiving attention.

CH₄+CO₂→2CO+2H₂(ΔH=247 kJ/mol) (1)

In the carbon dioxide reforming as above, synthesis gas having relatively high amount of carbon monoxide is produced.

Synthesis gas is widely utilized to prepare value-added compounds. For example, hydrogen in synthesis gas may be applied to hydrogen power generation, ammonia production and oil refining processes, and synthetic crude oil obtained from synthesis gas may be employed to prepare diesel, jet oil, lubricant oil and naphtha. Furthermore, using methanol prepared from synthesis gas, value-added chemicals such as acetic acid, olefin, dimethylether, aldehyde, fuel and additives may be obtained.

A nickel-based catalyst and a catalyst containing a precious metal such as Rh, Pt or Ir are known to reform carbon dioxide (Korean Patent Application Publication Nos. 1998-0050004 and 2005-0051820). Among these catalysts, the nickel-based catalyst may become deactivated due to attachment (deposition) of carbon during the reforming reaction, undesirably shortening the lifetime of the catalyst, and furthermore, performance of the catalyst may be deteriorated, which is attributed to sintering of the catalyst upon regeneration, compared to before regeneration (“Catalytic decomposition of Methane over Ni—Al2O3 coprecipitated catalyst reaction and regeneration studies”, Applied Catalysis A: General, 252, 363-383(2003)). On the other hand, the precious metal-containing catalyst may exhibit superior carbon dioxide reforming effects but is expensive and is thus difficult to commercialize.

Korean Patent Application Publication No. 2011-0064121 discloses a catalyst for carbon dioxide reforming, which is capable of maintaining high reaction activity for a long period of time by suppressing carbon deposition, which is regarded as problematic in an existing nickel-based catalyst. Specifically, this catalyst is configured such that a lanthanum (La) promoter and a nickel catalyst are uniformly supported on a carrier (Al₂O₃).

Also, F. Frusteri et al. (“Potassium-enhanced stability of Ni/MgO catalysts in the dry reforming of methane”, Catalysis Communications, 2, 49-56(2001)) has reported that, in carbon dioxide reforming of methane using a nickel-supported catalyst modified with potassium, coking resistance and thermal stability of nickel may be imparted due to the addition of potassium. However, this catalyst does not satisfactorily solve problems of low catalyst durability attributed to carbon deposition and low process efficiency due to reactor clogging.

Typically, synthesis gas produced by carbon dioxide reforming has high purity and may thus be utilized for various chemical products or process materials and also may be efficiently employed to produce hydrogen for a fuel cell.

Since the reaction route by Scheme (1) is endothermic and is a high energy integration process, reaction routes for producing synthesis gas, other than the carbon dioxide reforming, are known. Typical examples thereof may include methane-steam reforming (2) and partial oxidation of methane (3).

CH₄+H₂O→CO+3H₂ (2)

CH₄+0.5O₂→CO+2H (3)

As mentioned above, synthesis gas is used for Fischer-Tropsch reaction to thereby produce hydrocarbon oil such as gasoline, and may also be employed for synthesis of methanol. In Fischer-Tropsch reaction (4) and methanol synthesis (5), a ratio of carbon monoxide and hydrogen has to be 1:2.

nCO+2nH₂→CₙH₂ₙ+nH₂O (4)

CO+2H₂→CH₃OH (5)

However, in synthesis gas obtained by methane-steam reforming and carbon dioxide reforming, the ratio of carbon monoxide and hydrogen does not fall on 1:2, and even in partial oxidation of methane, the actual ratio of carbon monoxide and hydrogen is not 1:2 because of the side-reactions (6 and 7) as below. Accordingly, some of the product obtained from methane-steam reforming, partial oxidation of methane or carbon dioxide reforming may be subjected to water-gas shift reaction (8) or hydrogen may be additionally supplied so that the ratio of carbon monoxide and hydrogen may be adjusted to 1:2.

CH₄+1.5O₂→CO+2H₂O (6)

CH₄+2O₂→CO₂+2H₂O (7)

CO+H₂O→CO₂+H₂ (8)

In this regard, the reactions other than the carbon dioxide reforming, namely, methane-steam reforming and partial oxidation of methane, may generate carbon dioxide via the side-reaction (e.g. side-reaction of Scheme (7) upon partial oxidation of methane), and may thus be unsuitable for suppressing global warming due to the carbon dioxide. Particularly, it is reported that for methane-steam reforming, about 20% of a carbon source is converted into carbon dioxide, and for partial oxidation (gasification) of methane, about 50% of a carbon source is converted into carbon dioxide. Accordingly, there is a need for a method of effectively producing synthesis gas by carbon dioxide reforming of a hydrocarbon (especially methane).

Meanwhile, Korean Patent No. 10-0888247 and U.S. Pat. No. 6,670,058 disclose a process of preparing hydrogen gas and carbon without formation of carbon dioxide by thermally decomposing a hydrocarbon in a reactor. As such, it is noted that a carbon black catalyst or a carbonaceous catalyst be used. However, these patents are mainly focused on the production of hydrogen and are not a technique for producing synthesis gas by carbon dioxide reforming as in the present invention. Furthermore, such patents are intended to suppress the generation of coke upon thermal composition or to merely alleviate problems due to the deposition thereof, and the use thereof is not found therein.

### DISCLOSURE

### Technical Problem

Accordingly, embodiments of the present invention are intended to provide a process of producing synthesis gas by carbon dioxide reforming, which employs a carbon black catalyst so that catalytic activity is not deteriorated due to a carbon component generated in the carbon dioxide reforming, by solving problems with a nickel-based catalyst or a precious metal-containing catalyst conventionally useful for carbon dioxide reforming.

Also, embodiments of the present invention are intended to provide a method of recycling the carbon generated in the carbon dioxide reforming as above.

### Technical Solution

An aspect of the present invention provides a method of producing synthesis gas by carbon dioxide reforming, comprising: reacting a hydrocarbon and carbon dioxide in a fluidized-bed reactor using carbon black particles as a catalyst.

In an exemplary embodiment of the present invention, the hydrocarbon/carbon dioxide molar ratio may be about 1 to 10.

In an exemplary embodiment of the present invention, the fluidization rate in the fluidized-bed reactor may be about 1 to 30 times a minimum fluidization rate.

Another aspect of the present invention provides a method of producing synthesis gas by carbon dioxide reforming, comprising: a) supplying a hydrocarbon and carbon dioxide into a fluidized-bed reactor using carbon black particles as a catalyst; b) reacting the hydrocarbon and the carbon dioxide under fluidization conditions to prepare a gas product containing synthesis gas and simultaneously to form the carbon black particles in an increased amount in the reactor; c) separating the gas product and the carbon black particles from the fluidized-bed reactor; and d) separating at least a portion of the carbon black particles, and recycling a remainder of the carbon black particles into the fluidized-bed reactor.

In this embodiment, the method may further comprise e) milling the carbon black particles separated in d), recovering at least a portion of the milled carbon black particles, and recycling a remainder of the milled carbon black particles into the fluidized-bed reactor.

In an exemplary embodiment, the method may further comprise separating the synthesis gas from the gas product separated in c), and recycling the gas product into the fluidized-bed reactor.

### Advantageous Effects

According to embodiments of the present invention, synthesis gas can be produced by carbon dioxide reforming of a hydrocarbon using a carbon black catalyst, thus increasing reactivity and preventing the deterioration of the activity of the catalyst due to carbon deposition, which is regarded as problematic in a typical carbon dioxide reforming method.

Also, the molar ratio of hydrocarbon and carbon dioxide for reaction can be adjusted, thereby easily controlling the production ratio of carbon monoxide and hydrogen in synthesis gas. Furthermore, the use of a fluidized-bed reactor can solve a problem of reactor clogging due to carbon attachment (deposition).

Moreover, carbon (carbon black) generated from the carbon dioxide reforming can be reused as a catalyst for carbon dioxide reforming or can be utilized in a variety of applications.

### DESCRIPTION OF DRAWINGS

FIGS. 1a to 1c are views illustrating a reaction mechanism where carbon (carbon black) is generated in carbon dioxide reforming and attached (or deposited) to carbon black particles;

FIG. 2 is a schematic view illustrating a fluidized-bed reaction system for carbon dioxide reforming according to an embodiment of the present invention;

FIG. 3 is a schematic view illustrating a fluidized-bed reaction system for carbon dioxide reforming according to another embodiment of the present invention;

FIG. 4 is a graph illustrating the methane (CH₄) conversion under varying conditions in examples of the present invention;

FIG. 5 is a graph illustrating the carbon dioxide (CO₂) conversion under varying conditions in examples of the present invention;

FIG. 6 is a graph illustrating the hydrogen/carbon monoxide (H₂/CO) ratio under varying conditions in examples of the present invention; and

FIGS. 7a and 7b are TEM images illustrating the carbon black catalyst before reaction (fresh) and after reaction (used) in examples of the present invention.

### MODE FOR INVENTION

The present invention may be embodied by the following description. The following to description is to be understood as disclosing embodiments of the present invention, and the present invention is not necessarily limited thereto. Furthermore, the appended drawings are used to understand embodiments of the present invention and are not construed as limiting the present invention, and details of individual constituents may be properly understood by specific purposes in the related description as will be described below.

According to an embodiment of the present invention, when a hydrocarbon and carbon dioxide are reacted in the presence of a carbon black catalyst to produce synthesis gas of carbon monoxide and hydrogen, a fluidized-bed reactor may be used, and a hydrocarbon/carbon dioxide supply ratio may be optimally adjusted, thereby increasing reactivity and preventing coking due to carbon deposition.

Carbon Black

Generally, incomplete combustion or thermal decomposition of hydrocarbons may produce six-membered carbon rings, which are then converted into polycyclic aromatic compounds via dehydrogenation condensation, yielding carbon black crystallites having a carbon hexagonal network structure. As such, an assembly of such crystallites refers to “carbon black”. Whereas typical graphite has a three-dimensional order, carbon black has a two-dimensional order. The atomic structure model of carbon black may be represented by Structural Formula 1 below.

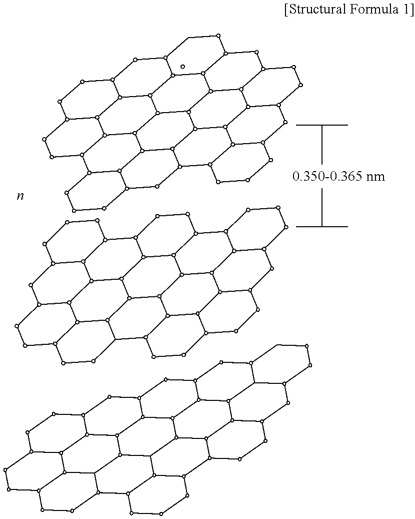

The relative density of carbon black is known to be about 1.76 to 1.9 depending on the grade thereof. The primary dispersible unit of carbon black refers to an aggregate (a separated rigid colloidal entity). Carbon black is mainly provided in the form of a sphere fused with such an aggregate. Such spheres are called primary particles or nodules.

The chemical composition of carbon black may vary depending on the source thereof, and is illustrated in Table 1 below.

TABLE 1

| Type | Carbon (%) | Hydrogen (%) | Oxygen (%) | Sulfur (%) | Nitrogen (%) | Ash (%) | Volatile (%) |
|---|---|---|---|---|---|---|---|
| Furnace (rubber- | 97.3-99.3 | 0.2-0.8 | 0.2-1.5 | 0.2-1.2 | 0.05-0.3 | 0.1-1.0 | 0.6-1.5 |
| grade) | | | | | | | |
| Medium | 99.4 | 0.3-0.5 | 0.12 or less | 0.25 or less | — | 0.2-0.38 | |
| Thermal acetylene | 99.8 | 0.05-0.1 | 0.1-0.15 | 0.02-0.05 | — | — | <0.4 |
| black | | | | | | | |

In an embodiment of the present invention, carbon black particles may include those variously prepared by incomplete combustion or thermal decomposition of hydrocarbons as above and the preparation mechanism thereof is widely known in the art. Examples of the mechanism may include (i) formation of a gaseous carbon black precursor at high temperature, (ii) nucleation, (iii) growth and aggregation of particles, (iv) surface growth, (v) agglomeration, and (vi) aggregate gasification.

Depending on changes in reaction conditions during the preparation process, the properties of carbon black may be adjusted. For example, when the temperature is increased, the thermal decomposition rate may increase and a larger number of nuclei may be formed, thus enlarging the surface area of carbon black. Also, the carbon black formation time may affect the properties of carbon black. For example, when the surface area is about 120 m²/g, a period of time of less than about 10 ms is required from atomization of oil to stoppage, and when the surface area is about 30 m²/g, the formation time may be a few tenths of a second.

The exemplary morphological characteristics of carbon black are shown in Table 2 below.

TABLE 2

| ASTM Class. | Aggregate size¹, D_{wm}², nm | Surface area¹, m²/g |
|---|---|---|
| N110 | 93 | 143 |
| N234 | 109 | 120 |
| N330 | 146 | 80 |
| N339 | 122 | 96 |
| N351 | 159 | 75 |
| N550 | 240 | 41 |
| N774 | 265 | 30 |
| N990 | 593 | 9 |

¹measured by TEM according to ASTM D3849,
²weight average diameter.

In an exemplary embodiment of the present invention, any type of carbon black (e.g. any carbon black in ASTM classification) that allows for carbon dioxide reforming may be used. Particularly, N330 grade carbon black is favorable in terms of good carbon dioxide reforming reactivity and profitability. The reason is that it is useful due to its high demand in tire preparation processes (e.g. as a tire strengthener) from the point of view of commercialization of carbon black generated in the reaction according to the embodiment of the present invention. Also, carbon black may be classified into carbon black for rubber (a kind of rubber reinforcement), carbon black for a pigment (a black pigment), and conductive carbon black, which may be used alone or in combination.

Hydrocarbon

According to an embodiment of the present invention, a hydrocarbon feed may include full-range hydrocarbon including C1 to C7 hydrocarbon (methane, ethane, ethylene, propane, to propylene, butane, etc.), naphtha and so on, or a mixture thereof. Particularly useful is methane.

Carbon Dioxide Reforming

In an embodiment of the present invention, carbon dioxide reforming in the presence of a carbon black catalyst involves Schemes 9 and 10 below.

CO₂+CH₄→2CO+2H₂ (9)

CO₂+2CH₄→2CO+4H₂+2C (10)

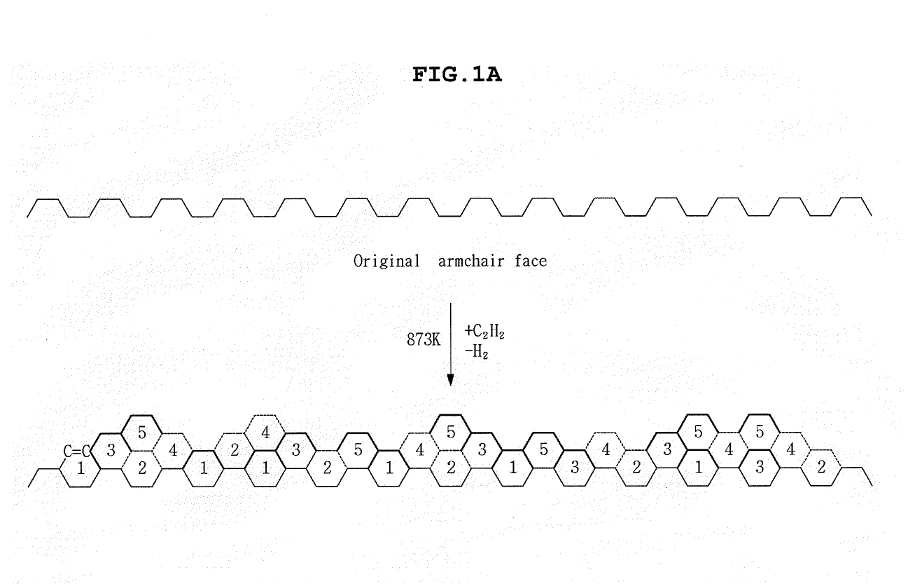

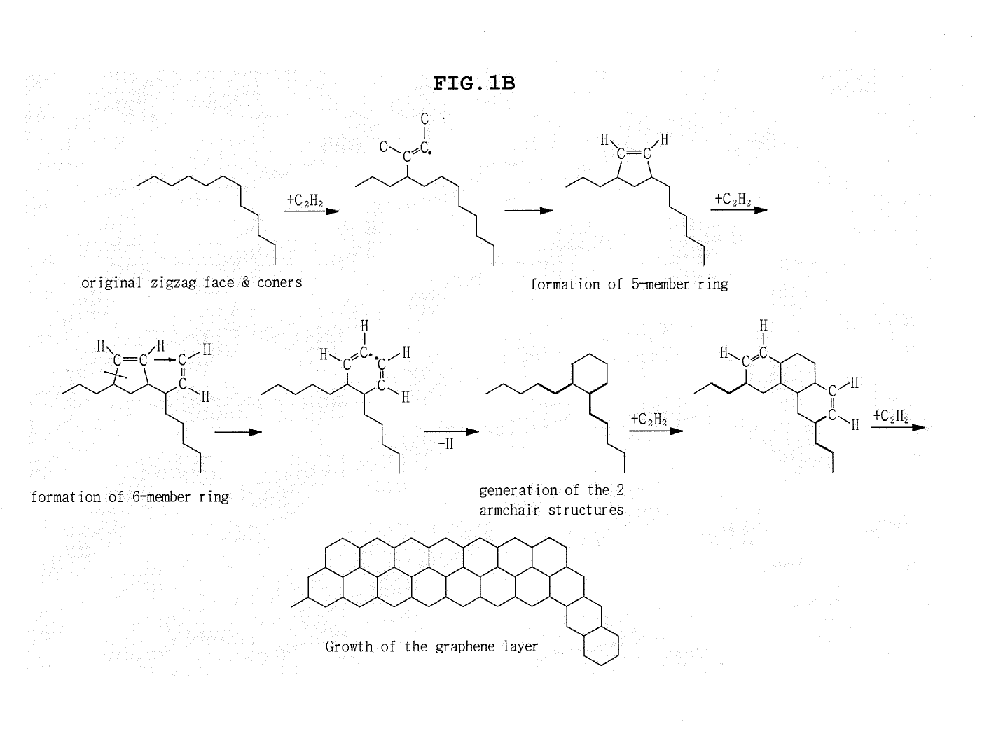

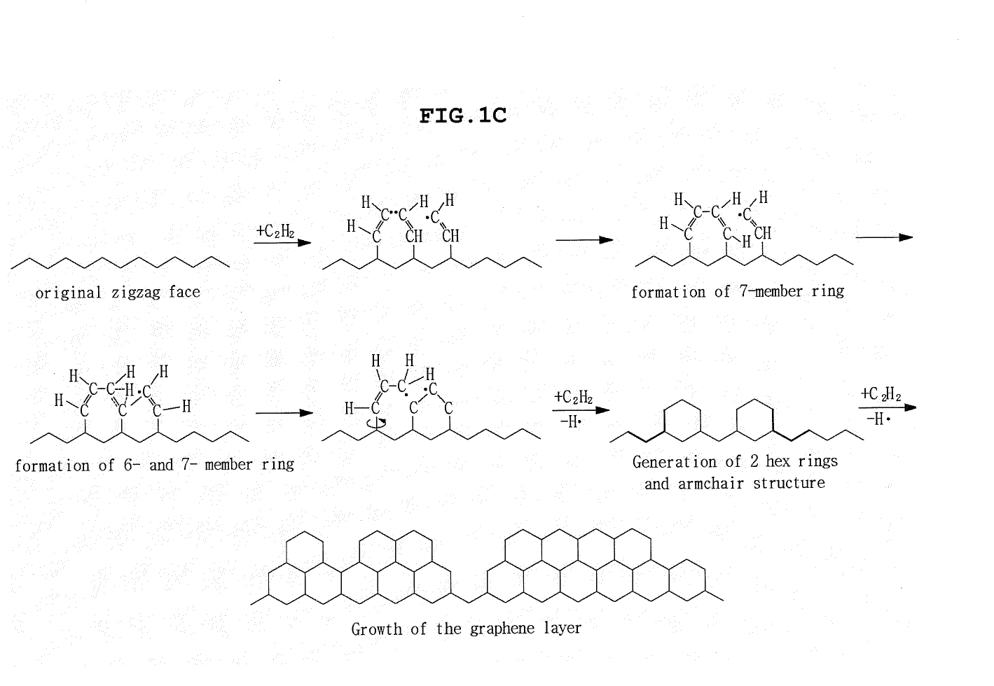

Although only synthesis gas is produced in Scheme 9, in Scheme 10, carbon is produced in addition to synthesis gas, and is then attached to the surface of a carbon black catalyst. The mechanism for forming carbon black on a carbon black catalyst (particles) is illustrated in FIGS. 1a to 1c.

As illustrated in the drawings, particles having an onion shaped microstructure are obtained due to fine carbon attachment or deposition using a zigzag face, corners or an armchair face of the surface of carbon black particles as a kind of template. As such, the resulting particles may have a particle size larger than existing carbon black particles on account of the generation and attachment of carbon (i.e. carbon content in the reactor is increased). Further, upon carbon attachment (deposition), the armchair or zigzag face on the surface of the carbon black catalyst may be formed, and thus the specific surface area thereof may be maintained as it is.

In an embodiment of the present invention, the carbon dioxide reforming may be carried out in fluidized-bed reaction. To this end, a fluidized-bed reactor may be exemplified by a riser, a bubbling reactor or a turbulent reactor, as known in the art. Upon fluidized-bed reaction, the reaction time may be set to, for example, about 1 to 120 sec, particularly about 5 to 100 sec, and more particularly about 10 to 80 sec. Also, the fluidization rate may be, for example, about 1 to 30 times, particularly about 1 to 20 times and more particularly about 1 to 10 times the minimum fluidization velocity. The reaction pressure is not particularly limited, but may be about 1 to 15 bar, and particularly about 1 to 10 bar.

In an exemplary embodiment of the present invention, preheating of the carbon black particles before the fluidization reaction may be effective at increasing the reaction efficiency. As such, the preheating temperature may be, for example, about 300 to 500° C., and particularly about 350 to 450° C. Also, the kind of carrier gas for use in fluidization is not specifically limited so long as it is an inert gas. For example, nitrogen, argon or the like may be useful.

In an embodiment of the present invention, the optimal ratio of carbon monoxide and hydrogen in the produced synthesis gas may be needed, and the hydrocarbon/carbon dioxide supply ratio into the fluidized-bed reactor may be adjusted to increase the reactivity. The hydrocarbon/carbon dioxide supply ratio may be, for example, a molar ratio of about 1 to 10, particularly about 1 to 5, and more particularly about 1 to 3. As such, when the hydrocarbon/carbon dioxide molar ratio is adjusted to about 2 to 3, especially about 3, the reactivity of the reforming feed may be improved, and thus coking due to carbon deposition may be suppressed, and the H₂/CO molar ratio in the produced synthesis gas may be increased. In addition, the carbon dioxide reforming may be carried out at, for example, about 600 to 1100° C., particularly about 700 to 1000° C., and more particularly about 800 to 900° C.

According to an exemplary embodiment, in the carbon dioxide reforming, the hydrocarbon conversion may be typically about 20 to 60%, particularly about 30 to 50%, and more particularly about 35 to 45%. Also, the carbon dioxide conversion may be about 35 to 85%, particularly about 40 to 80%, and more particularly about 60 to 80%. Also, the H₂/CO molar ratio in the synthesis gas may be about 0.5 to 2.0, and particularly about 1 to 1.5.

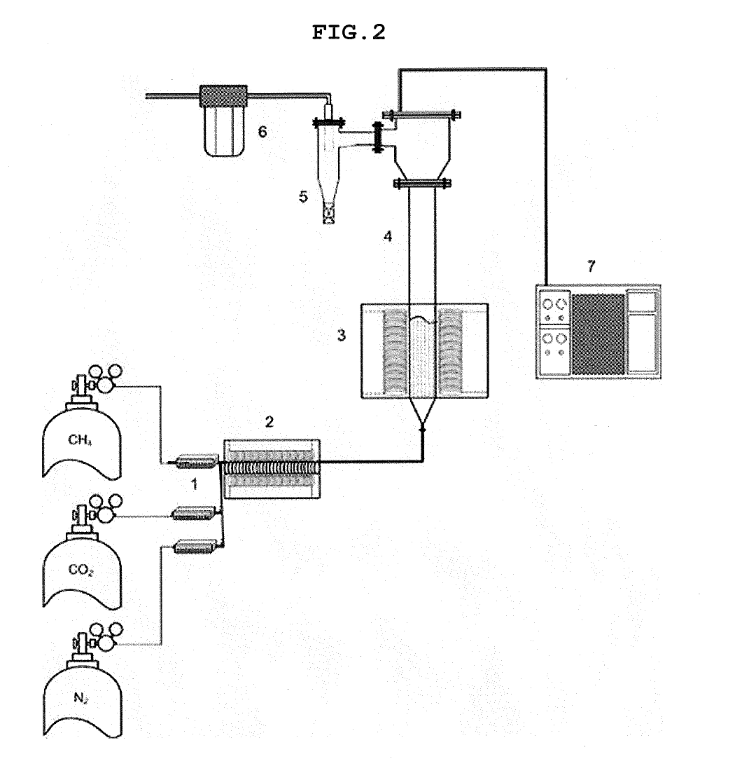

FIG. 2 schematically illustrates a lab-scale structure of a fluidized-bed reaction system for carbon dioxide reforming according to an embodiment of the present invention.

Using a mass flow controller 1, methane, carbon dioxide and nitrogen gases are supplied to at an appropriate flow rate from respective gas suppliers, and then preheated to 300 to 500° C. by means of a preheater 2. The preheated gas components are heated to 700 to 1000° C. in a furnace 3 and then supplied to the bottom of the fluidized-bed reactor 4, and are reacted with a carbon black catalyst previously provided in the reactor. The carbon generated in the reaction is attached to the surface of the carbon black catalyst (particles). The produced gas mixture (gas product) of hydrogen and carbon monoxide is collected through a cyclone 5 and a bag filter 6. As such, the carbon black catalyst (particles) configured such that the carbon generated in the reaction is attached thereto is collected in the bag filter 6 through the cyclone 5. As necessary, the gas product may be transferred to a gas chromatograph (GC) 7 and thus analyzed.

In this embodiment, it is noted that the use of carbon black as the catalyst for carbon dioxide reforming may suppress the deterioration of the activity due to carbon generated in the reaction, and also that carbon black attached to the catalyst may be commercialized.

Meanwhile, according to another embodiment of the present invention, carbon (carbon black) generated from carbon dioxide reforming may be reused as a catalyst for carbon dioxide reforming or may be utilized in a variety of applications.

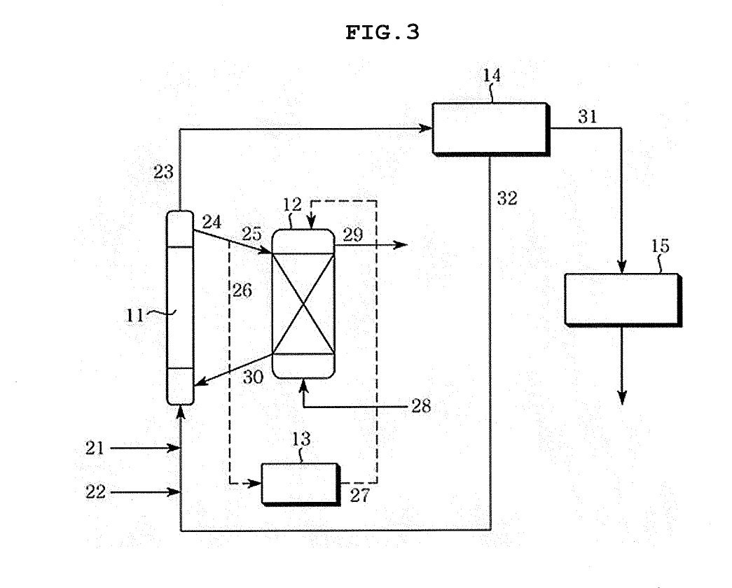

FIG. 3 schematically illustrates a fluidized-bed reaction system for carbon dioxide reforming according to another embodiment of the present invention.

The system illustrated in the drawing includes a riser 11, a preheating unit 12, a milling unit 13, a gas product separation unit 14, and a compound synthesis unit 15. Although a single riser is depicted in this embodiment, a plurality of (two) risers may be disposed parallel to each other and may be connected to the preheating unit, as necessary.

A hydrocarbon 21 and carbon dioxide 22 are supplied through the bottom of the riser 1. As such, a carbon black catalyst (not shown) in the riser is fluidized by the action of a carrier gas (not shown). So long as the carbon black catalyst may be fluidized, it is not limited to specific forms. When commercially available fresh carbon black is used from the beginning, it may include molded particles (e.g. molded pellets, specifically spherical molded pellets), and when it is milled and then supplied into the reactor as mentioned later, it may be in fine particle form.

After completion of the reforming reaction between hydrocarbon and carbon dioxide under fluidization conditions, a gas product 23 and a solid product 24 (carbon black particles) are separated by a gas-solid separator (not shown; e.g. a cyclone) positioned at the top of the riser. As such, the carbon black particles as the solid product are configured such that carbon generated in the reforming reaction is attached to the surface thereof, and thus such particles have a particle size larger than original particles. Thereafter, at least a portion 26 of the solid product is separated and transferred to a milling unit 13. The milling unit 13 may be, for example, a ball milling machine (especially a dry type), and such a ball milling machine is known in the art. As necessary, the solid product 24 may be totally transferred to the milling unit 13.

The remainder 25 of the solid product 24, which is not transferred to the milling unit 13, is transferred to the top of the preheating unit 12. A mixture 28 of fuel (oil) and air is supplied to the bottom of the preheating unit 12 and combusted, whereby the solid product in the preheater is heated, and the produced gas (carbon dioxide, water, nitrogen, etc.) is discharged through a line 29. Also, the milling unit 13 functions to mill the solid product 26. As such, the size of the carbon black particles enlarged due to the attachment of carbon generated in the reforming reaction is decreased (returns to an original particle size), and furthermore, carbon black in a fine particle phase is obtained. At least a portion (not shown) of the milled carbon black may be recovered as a carbon black product, and the remainder thereof is recycled to the top of the preheating unit 12 via a line 27 and thus combined with the previously introduced carbon black particles 25, preheated and then supplied (recycled) to the bottom of the riser 11 via a line 30 from the bottom of the preheating unit 12. If a fresh carbon black catalyst is not used, the amount of carbon black that is recovered as a product may be adjusted so as to provide a catalyst in an amount sufficient for the subsequent reforming reaction by only the combination of the solid product remainder 25 and the recycled particles 27. Alternatively, the milled carbon black may be totally recovered as a product, and a fresh carbon black catalyst may be further placed in the riser 11 via an additional line.

The gas product 23 is transferred to a gas product separation unit 14, so that it is separated into synthesis gas (31; a gas mixture of CO and H₂) and an unreacted gas material (32; hydrocarbon and carbon dioxide). As such, the gas product separation unit may be typically a PSA (pressure swing adsorption) separator. Specifically, an adsorbent adapted for PSA, such as zeolite, activated carbon, silica gel or alumina, may be pressurized, so that the synthesis gas (carbon monoxide and hydrogen) is adsorbed into the adsorbent, after which the gas remainder (hydrocarbon and carbon dioxide) is discharged, followed by detaching the adsorbed synthesis gas by depressurization, thus increasing purity of the product. Such separation operation and process conditions are known in the art, and a detailed description thereof is thus omitted in this specification. In addition to the PSA separation process, various separation processes known in the art, for example, separation membrane, distillation, etc. may be utilized. On the other hand, the unreacted gas material 32 is recycled, combined with newly supplied reaction materials 21, 22, and then supplied into the riser 11.

Thereafter, the separated synthesis gas 31 may be utilized for preparation of various chemicals, fuels, etc. as mentioned above. Depending on the type of target chemical, the H₂/CO molar ratio in the synthesis gas may be adjusted. In this case, a WGS (water-gas shift) reactor may be provided to increase the hydrogen ratio.

The synthesis gas 31 may be converted into a variety of materials in the compound synthesis unit 15. For example, methanol may be prepared, or hydrocarbon oil may be obtained via Fischer-Tropsch reaction.

A better understanding of the present invention may be obtained via the following examples which are set forth to illustrate, but are not to be construed as limiting the present invention.

### EXAMPLES

### Example 1

### CO₂ Reforming Using Carbon Black Catalyst

Using a reaction system illustrated in FIG. 2, carbon dioxide reforming of methane was performed.

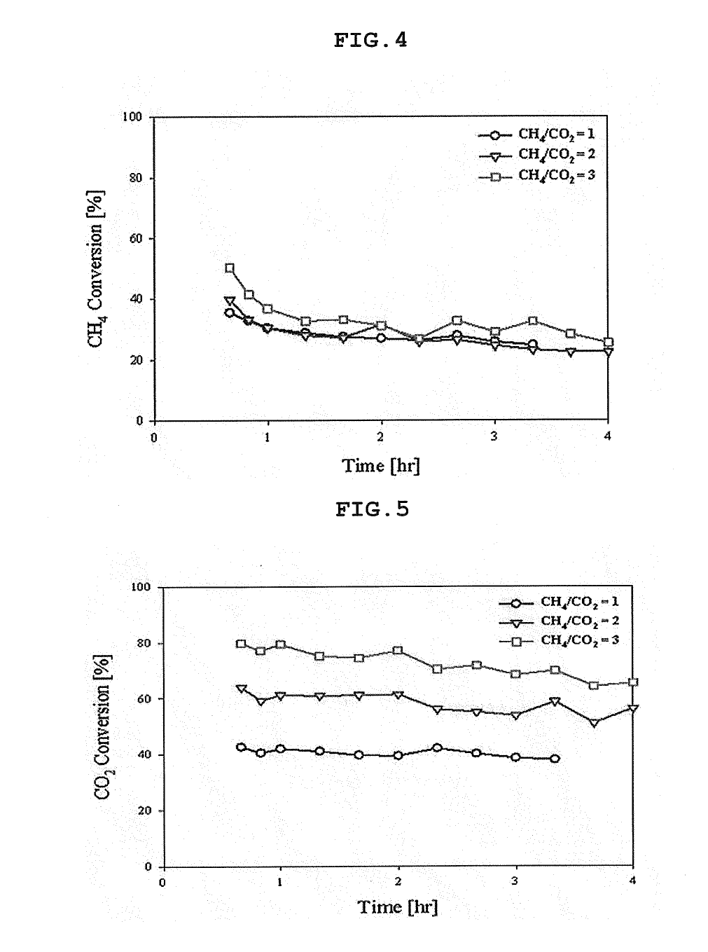

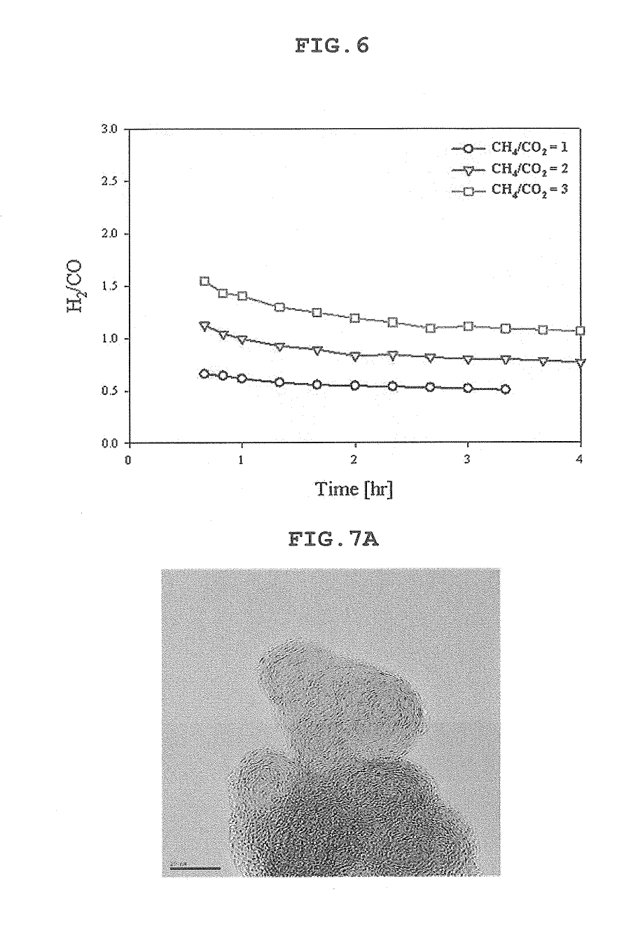

As such, a fluidized-bed reactor (a riser) having a diameter of 5.5 cm and 200 g of a N330 pellet type carbon black catalyst were used. The reaction temperature was 850° C., the flow rate was 1.8 cm/s and the CH₄/CO₂ supply ratio was adjusted to 1, 2 or 3, so that the reforming reaction was carried out. After the reaction, the gas product was analyzed by gas chromatography. When the CH₄/CO₂ supply ratio (molar ratio) was 1 (-∘-), 2 (-∇-) or 3 (-□-), the methane (CH₄) conversion, carbon dioxide (CO₂) conversion and hydrogen/carbon monoxide (H₂/CO) ratio are shown in FIGS. 4, 5 and 6, respectively.

As illustrated in these drawings, as the CH₄/CO₂ supply ratio in the reforming feed was higher, the CH₄ conversion and the CO₂ conversion were increased; furthermore, the H₂/CO molar ratio in the produced synthesis gas was increased. Therefore, the most desirable results are considered to be obtained at a CH₄/CO₂ supply ratio of 3.

Also, the CH₄ conversion, the CO₂ conversion and the H₂/CO molar ratio in synthesis gas slightly varied depending on the reaction time, but were maintained relatively constant. This means that the use of the carbon black catalyst may suppress the deactivation of the catalyst due to attachment (deposition) of carbon generated in the reaction.

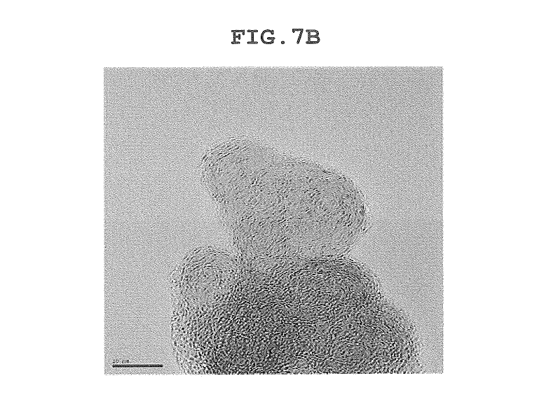

Meanwhile, the fresh carbon black catalyst before the reforming reaction and the carbon black catalyst after the reforming reaction were observed with TEM. The results are shown in FIGS. 7a and 7b. As illustrated in these images, the carbon black catalyst has carbon deposited to thereon as a result of the reforming reaction, but may maintain properties of carbon black. Hence, this catalyst is expected to keep its activity adapted for carbon dioxide reforming

### Example 2

### Simulation Test

Based on the results of Example 1, a simulation test was performed for the process illustrated in FIG. 3. As such, the diameter (ID) and the height of a riser 11 were set to 2 m and 40 m, respectively, and the reaction temperature and the reaction pressure were respectively adjusted to 900° C. and 10 bar. Furthermore, the reaction time was set to about 4 sec. The CH₄/CO₂ molar ratio in the feed, the CH₄ conversion and the CO₂ conversion are given in Table 3 below.

TABLE 3

| CH₄/CO₂ molar ratio | CH₄ conversion (%) | CO₂ conversion (%) |
|---|---|---|
| 4:1 | 43 | 80 |

The composition per line of the reaction system is given in Table 4 below.

TABLE 4

| Line | CH₄ (ton/day) | CO₂ (ton/day) | CO (ton/day) | H₂ (ton/day) |
|---|---|---|---|---|
| 21 | 1480 | | | |
| 22 | | 2030 | | |
| 23 | 2220 | 508 | 2584 | 372 |
| 31 | | | 2584 | 372 |
| 32 | 2220 | 508 | | |

When methanol is synthesized using the obtained synthesis gas in Table 4, methanol of about 2500 ton/day can be assumed to result.

Accordingly, simple modifications, additions and substitutions of the present invention should be understood as falling within the scope of the present invention, without departing from the scope and spirit of the invention as disclosed in the accompanying claims.

### DESCRIPTION OF THE REFERENCE NUMERALS IN THE DRAWINGS

1: mass flow controller
2: preheater
3: furnace
4: fluidized-bed reactor
5: cyclone
6: bag filter
7: gas chromatograph (GC)
11: riser
12: preheating unit
13: milling unit
14: gas product separation unit
15: compound synthesis unit

1. A method of producing synthesis gas by carbon dioxide reforming, comprising: reacting a hydrocarbon and carbon dioxide in a fluidized-bed reactor using carbon black particles as a catalyst.

2. The method of claim 1, wherein a hydrocarbon/carbon dioxide ratio is 1 to 10.

3. The method of claim 2, wherein the hydrocarbon/carbon dioxide ratio is 1 to 5.

4. The method of claim 3, wherein the hydrocarbon/carbon dioxide ratio is 1 to 3.

5. The method of claim 1, wherein a fluidization velocity in the fluidized-bed reactor is 1 to 30 times a minimum fluidization velocity.

6. The method of claim 1, wherein reacting the hydrocarbon and the carbon dioxide is performed at a temperature of 700 to 1000° C. at a pressure of 1 to 15 bar.

7. The method of claim 1, wherein reacting the hydrocarbon and the carbon dioxide is performed for 1 to 120 sec.

8. The method of claim 1, further comprising preheating the carbon black particles as the catalyst to 300 to 500° C. and then supplying the catalyst into the fluidized-bed reactor, before reacting the hydrocarbon and the carbon dioxide.

9. The method of claim 1, further comprising preheating each of the hydrocarbon and the carbon dioxide to 300 to 500° C., before reacting the hydrocarbon and the carbon dioxide.

10. A method of producing synthesis gas by carbon dioxide reforming, comprising:
a) supplying a hydrocarbon and carbon dioxide into a fluidized-bed reactor using carbon black particles as a catalyst;
b) reacting the hydrocarbon and the carbon dioxide under fluidization conditions to prepare a gas product containing synthesis gas and simultaneously to form the carbon black particles in an increased amount in the reactor;
c) separating the gas product and the carbon black particles from the fluidized-bed reactor; and
d) separating at least a portion of the carbon black particles, and recycling a remainder of the carbon black particles into the fluidized-bed reactor.

11. The method of claim 10, further comprising e) milling the carbon black particles separated in d), recovering at least a portion of the milled carbon black particles, and recycling a remainder of the milled carbon black particles into the fluidized-bed reactor.

12. The method of claim 10, further comprising separating the synthesis gas from the gas product separated in c), and recycling the remainder of the gas product into the fluidized-bed reactor.

13. The method of claim 12, wherein separating the synthesis gas from the gas product is performed by PSA (pressure swing adsorption).

14. The method of claim 12, further comprising treating the separated synthesis gas in a WGS (water-gas shift) reactor.

15. The method of claim 10, wherein the carbon black particles are N330 grade carbon black particles.

16. The method of claim 10, wherein the hydrocarbon is C1 to C7 hydrocarbon or naphtha.

17. The method of claim 16, wherein the hydrocarbon is methane.
